(19) United States
(12) Patent Application Publication
(10) Pub. No.: US 2006/0219987 A1
(43) Pub. Date: Oct. 5, 2006

(54) Insulating film, process for producing the same and electronic device having the same

(75) Inventors: Akira Asano, Shizuoka (JP); Katsuyuki Watanabe, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/374,032

(22) Filed: Mar. 14, 2006

(30) Foreign Application Priority Data
Mar. 14, 2005 (JP) P.2005-071154

(51) Int. Cl. H01B 1/24; H01B 1/06

(52) U.S. Cl. 252/510

(57) ABSTRACT

An insulating film comprising a compound having a cage structure, wherein the insulating film has a coefficient of linear expansion of 120×10⁻⁶ K⁻¹ or less; an insulating film, which is obtained by a method comprising: irradiating a film-forming composition containing a compound having a cage structure with electron beams so as to cure the film-forming composition; and an electronic device comprising the insulating film.

### BACKGROUND OF THE INVENTION

1. Field of the Invention

The present invention relates to an insulating film and, more precisely, to an insulating film for use in electronic devices which has good film properties such as a good coefficient of linear expansion, a good dielectric constant and good mechanical properties, to a process for forming the insulating film and to an electronic device having the insulating film.

2. Description of the Related Art

In recent years, accompanied by the progress of high integration, multifunction and high performance in the field of electronic materials, circuit resistance and condenser capacity between wirings have been increased thus causing increase of electric power consumption and delay time. Particularly, increase of delay time becomes a large factor for the reduction of signal speed of devices and generation of crosstalk, so that reduction of parasitic resistance and parasitic capacity are in demand for the purpose of attaining acceleration of devices by reducing this delay time. As one of the concrete measures for reducing this parasitic capacity, an attempt has been made to cover periphery of wiring with a low dielectric layer insulating film. Also, the layer insulating film is expected to have superior heat resistance which can withstand the thin film formation step at the time of mounting substrate production and chip connection, pin attachment and the like post steps and also chemical resistance that can withstand wet process. In addition, a low resistance Cu wiring has been introduced in recent years instead of the Al wiring, and accompanied by this, flattening by CMP (chemical mechanical polishing) is commonly carried out, so that high mechanical strength which can withstand this process is in demand.

Polybenzoxazole and polyimide are widely known for insulating films of good heat resistance. However, since they contain a nitrogen atom of high polarity, they could not form films that are satisfactory in point of the necessary low level of dielectric constant, the water absorption resistance, the durability and the hydrolysis resistance.

In general, many organic polymers are poorly soluble in organic solvent, and a technique of preventing polymer deposition in coating solutions and preventing depositions in insulating films is an important theme in the art. To solve the problems, when the polymers are so modified that their main chain has a folded structure in order to have an increased solubility, then their glass transition point lowers and their heat resistance also lowers, and, after all, it is not easy to obtain polymers that satisfy both the intended properties and the solubility.

Also, there has been known a highly heat-resistant resin having a backbone structure (main chain) of polyarylene ether (U.S. Pat. No. 6,509,415) which has a dielectric constant in the range of from 2.6 to 2.7. However, it is desired to further lower the dielectric constant of the resin for realizing high-speed devices. It is also desired not to make a film porous but to make the film have a bulk specific dielectric constant of 2.6 or less, more preferably 2.5 or less.

As a technique for improving dielectric constant and mechanical strength of an interlayer insulating film, there have been tried a method of irradiating the interlayer insulating film with electron beams as well as improvement of materials. It has been known that chemical bonds in the insulating film are changed by irradiation of the interlayer insulating film with electronic beams, leading to reduction of dielectric constant, an increased mechanical strength and improvement of adhesion to the undercoated film.

As is described above, various techniques such as irradiation with electron beams have been made to improve the interlayer insulating film. However, in the point of obtaining a low coefficient of linear expansion which is one of the characteristic properties having recently been required for the interlayer insulating film, there have not been obtained satisfactory insulating films. A large difference in coefficient of linear expansion between the interlayer insulating film and copper (16.5×10⁻⁶K⁻¹) to be used in wiring of a semiconductor device would generate a large stress at the interface between the interlayer insulating film and copper upon thermal treatment in the production steps due to the large difference in coefficient of linear expansion, resulting in a deteriorated reliability. In particular, it is well known that, when an organic polymer-based insulating film is used as the interlayer insulating film, it is difficult to practically produce semiconductor devices due to the large coefficient of expansion of the film.

### SUMMARY OF THE INVENTION

The present invention relates to an insulating film (also referred to as a “dielectric film” and a “dielectric insulating film”, and these terms are not substantially distinguished) having good film properties such as a good coefficient of linear expansion, a good dielectric constant and good mechanical properties and to an electronic device having the insulating film.

As a result of intensive investigations to solve the above-mentioned problems, the present inventors have surprisingly succeeded in obtaining an insulating film having a low coefficient of linear expansion from an organic polymer by irradiating a film-forming composition containing a cage type compound with electron beams to thereby cure the composition.

That is, the present inventors have found that the above-mentioned problems can be solved by the constitutions of (1) to (10) mentioned below.

(1) An insulating film comprising a compound having a cage structure,

wherein the insulating film has a coefficient of linear expansion of 120×10⁻⁶ K⁻¹ or less.

(2) An insulating film, which is obtained by a method comprising:

irradiating a film-forming composition containing a compound having a cage structure with electron beams so as to cure the film-forming composition.

(3) The insulating film as described in (2) above,

wherein the insulating film has a coefficient of linear expansion of 120×10⁻⁶ K⁻¹ or less.

(4) The insulating film as described in any of (1) to (3) above,

wherein the cage structure is a saturated hydrocarbon structure.

(5) The insulating film as described in any of (1) to (4) above,

wherein a ratio of all carbon atoms of the cage structure to all carbon atoms of a total solid content of the film-forming composition is 30% or more.

(6) The insulating film as described in any of (1) to (5) above,

wherein the cage structure is a diamantane structure.

(7) The insulating film as described in (6) above,

wherein the compound having a cage structure is a polymer of at least one compound represented by formula (I):

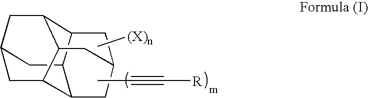

wherein R represents a hydrogen atom, an alkyl group, an alkenyl group, an alkynyl group, an aryl group or a silyl group;

m represents an integer of from 1 to 14;

X represents a halogen atom, an alkyl group, an alkenyl group, an aryl group or a silyl group; and

n represents an integer of from 0 to 13.

(8) The insulating film as described in any of (1) to (7) above,

wherein the compound having a cage structure is a compound that does not contain a nitrogen atom.

(9) A process for producing an insulating film, which comprises:

irradiating a film-forming composition containing a compound having a cage structure with electron beams.

(10) An electronic device comprising an insulating film as described in any of (1) to (8) above.

### DETAILED DESCRIPTION OF THE INVENTION

The invention will be described in detail below.

<Compound Having a Cage Structure>

The “cage structure” as referred to herein is meant to indicate a molecule in which the plural rings formed of covalent-bonded atoms define the capacity of the structure and in which all points existing inside the capacity could not leave the capacity without passing through the rings. For example, an adamantane structure may be considered as the cage structure. Contrary to this, a single crosslink-having cyclic structure such as norbornane (bicyclo[2,2,1]heptane) could not be considered as the cage structure since the ring of the single-crosslinked cyclic compound does not define the capacity of the compound.

The number of all carbon atoms of the cage structure in the invention is preferably from 10 to 30, more preferably from 11 to 18, particularly preferably 14.

The carbon atoms that constitute the cage structure do not include the carbon atoms of the linking group and the substituent bonding to the cage structure. For example, the cage structure of 1-methyladamantane is composed of 10 carbon atoms, and the cage structure of 1-ethyldiamantane is composed of 14 carbon atoms.

Preferably, the compound of the invention having a cage structure is a saturated hydrocarbon. Preferred examples of the cage structure are diamond-like adamantanes, diamantanes, triamantanes, tetramantanes and dodecahedranes as having good heat resistance. Of those, diamantanes and triamantanes are preferred as having a lower dielectric constant; and diamantanes are particularly preferred as easy to synthesize.

The cage structure in the invention may have one or more substituents, and examples of the substituent include a halogen atom (a fluorine atom, a chlorine atom, a bromine atom or an iodine atom), a straight-chained, branched or cyclic alkyl group containing from 1 to 10 carbon atoms (e.g., methyl, t-butyl, cyclopentyl or cyclohexyl), an alkenyl group containing from 2 to 10 carbon atoms (e.g., vinyl or propenyl), an alkynyl group containing from 2 to 10 carbon atoms (e.g., ethynyl or phenylethynyl), an aryl group containing from 6 to 20 carbon atoms (e.g., phenyl, 1-naphthyl or 2-naphthyl), an acyl group containing from 2 to 10 carbon atoms (e.g., benzoyl), an aryloxy group containing from 6 to 20 carbon atoms (e.g., phenoxy), an arylsulfonyl group containing from 6 to 20 carbon atoms (e.g., phenylsulofonyl), a nitro group, a cyano group, and a silyl group (e.g., triethoxysilyl, methyldiethoxysilyl or trivinylsilyl). Of these, a fluorine atom, a bromine atom, a straight-chained, branched or cyclic alkyl group containing from 1 to 5 carbon atoms, an alkenyl group containing from 2 to 5 carbon atoms, an alkynyl group containing from 2 to 5 carbon atoms and a silyl group are preferred substituents. These substituents may further be substituted by other substituent.

Preferably, the cage structure in the invention has one to four substituent(s), more preferably two or three substituents, still more preferably two substituents. The substituent bonding to the cage structure may be a mono- or more poly-valent substituent or a di- or more poly-valent linking group.

The “compound having a cage structure” as used herein in the invention may be either a low molecular weight compound or a high molecular weight compound (e.g., a polymer), but preferred is a polymer. When the compound having a cage structure is a polymer, its weight average molecular weight is preferably from 1,000 to 500,000, more preferably from 5,000 to 300,000, particularly preferably from 10,000 to 200,000. The polymer having a cage structure may be contained in a film-forming composition as a resin composition having a molecular weight distribution. When the compound having a cage structure is a low molecular weight compound, its molecular weight is preferably 3,000 or less, more preferably 2,000 or less, particularly preferably 1,000 or less.

The cage structure in the invention may be incorporated into a polymer principal chain as a monovalent pendant group. As a desirable polymer principal chain to which a cage structure is bonded, there are illustrated conjugated linking chains such as poly(arylene), poly(arylene ether), poly(ether) and polyacetylene, and polyethylene. Of these, poly(arylene ether) and polyacetylene are particularly desirable with respect to a good heat resistance.

It is particularly desirable that the cage structure of the invention forms a part of a polymer principal chain when the compound having a cage structure is a polymer. That is, when it forms a part of a polymer principal chain, it means that polymer chain is cut off when the cage compound is removed from this polymer. In this embodiment, the cage structure is directly single-bonded or connected by an appropriate divalent connecting group. Examples of the connecting group include —C(R¹¹)(R¹²)—, —C(R¹³)═C(R¹⁴)—, —C≡C—, arylene group, —CO—, —O—, —SO₂—, —N(R¹⁵)—, —Si(R¹⁶)(R¹⁷)— and a group as a combination thereof. In this case, R₁₁ to R₁₇ each independently represents a hydrogen atom, an alkyl group, an alkenyl group, an alkynyl group, an aryl group or an alkoxy group. These connecting groups may be substituted with a substituting group, and for example, the aforementioned substituting groups can be cited as preferred examples.

More preferred connecting groups among them is —C(R¹¹)(R¹²)—, —CH═CH—, —C≡C—, an arylene group, —O—, —Si(R¹⁶)(R⁷)— or a group as a combination thereof, and particularly preferred is —CH═CH—, —C≡C—, —O—, —Si(R¹⁶)(R⁷)— or a group as a combination thereof.

The “compound having a cage structure” to be used in the invention may contain one or two or more species of the cage structures in the molecule of the compound.

Specific examples of the compound having a cage structure are shown below, to which, however, the invention is not limited.

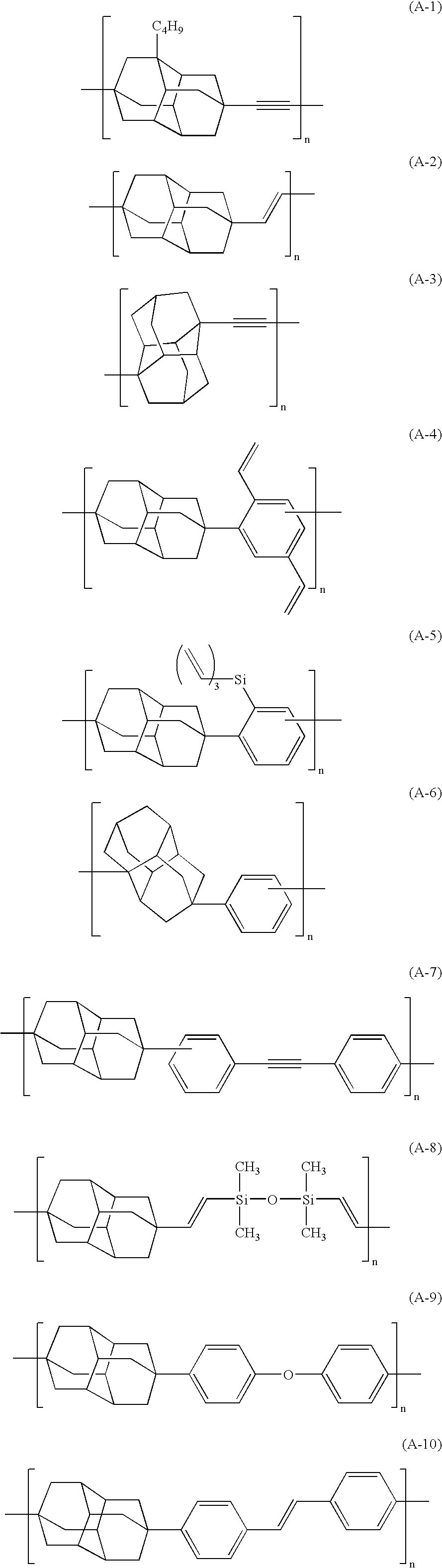

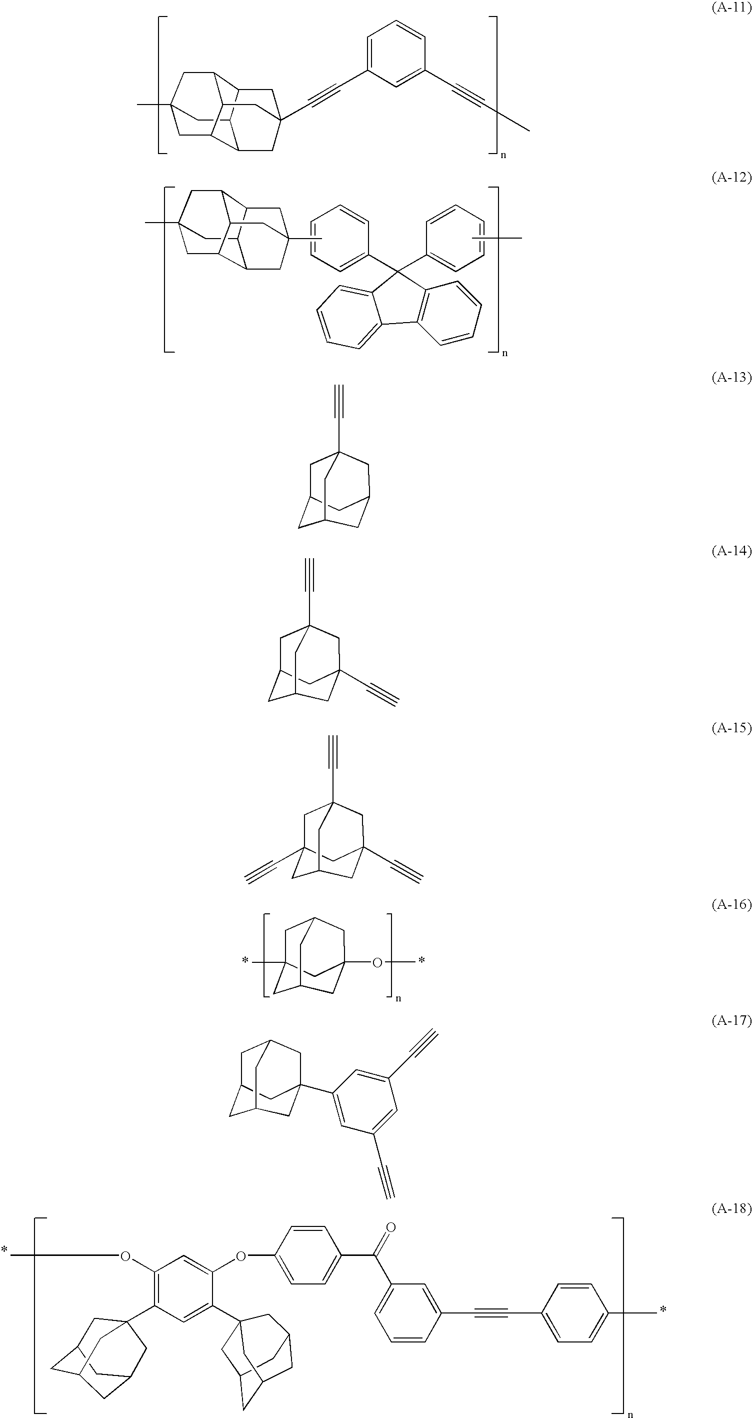

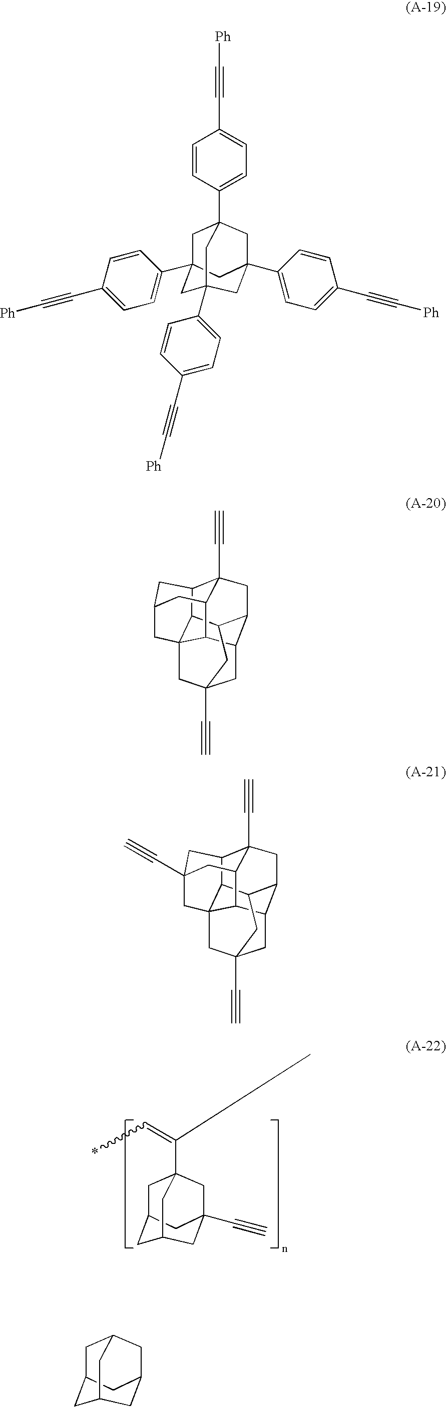

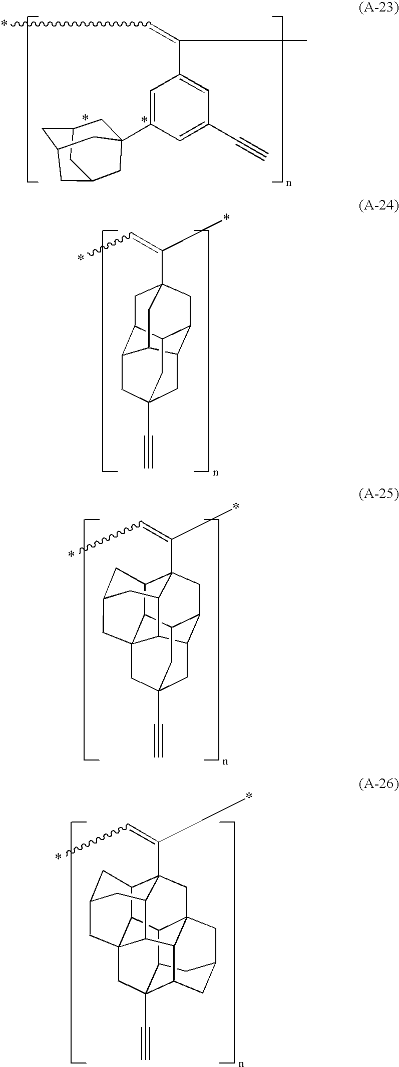

Especially preferably, the compound of the invention having a cage structure is a polymer of a compound of the following formula (I):

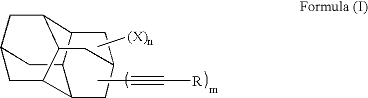

In the formula (I),

R represents a hydrogen atom, an alkyl group (preferably containing from 1 to 10 carbon atoms), an alkenyl group (preferably containing from 2 to 10 carbon atoms), an alkynyl group (preferably containing from 2 to 10 carbon atoms), an aryl group (preferably containing from 6 to 20 carbon atoms) or a silyl group (preferably containing from 0 to 20 carbon atoms.

When R dose not represent a hydrogen atom, R may further be substituted by other substituent. Examples of such substituent include a halogen atom (a fluorine atom, a chlorine atom, a bromine atom or an iodine atom), an alkyl group, an alkenyl group, an alkynyl group, an aryl group, an acyl group, an aryloxy group, an arylsulfonyl group, a nitro group, a cyano group and a silyl group.

R preferably represents a hydrogen atom, an alkyl group containing from 1 to 10 carbon atoms, an aryl group containing from 6 to 20 carbon atoms or a silyl group containing from 0 to 20 carbon atoms, more preferably represents a hydrogen atom or a silyl group containing from 0 to 10 carbon atoms.

m represents an integer of from 1 to 14, preferably from 1 to 4, more preferably from 1 to 3, particularly preferably 2 or 3.

X represents a halogen atom, an alkyl group (preferably containing from 1 to 10 carbon atoms), an alkenyl group (preferably containing from 2 to 10 carbon atoms), an aryl group (preferably containing from 6 to 20 carbon atoms) or a silyl group (preferably containing from 0 to 20 carbon atoms).

X may further be substituted by other substituent. As examples of such substituent, there may be illustrated the same ones as have been illustrated hereinbefore. X preferably represents a fluorine atom, a chlorine atom, a bromine atom, an alkyl group containing from 1 to 10 carbon atoms, an alkenyl group containing from 2 to 10 carbon atoms or a silyl group containing from 0 to 20 carbon atoms, with a bromine atom, an alkenyl group containing from 2 to 4 carbon atoms or a silyl group containing from 0 to 10 carbon atoms being more preferred.

n represents an integer of from 0 to 13, preferably from 0 to 3, more preferably from 0 to 2, particularly preferably 0 or 1.

Polymerization of the compound of formula (I) is optimally conducted in an organic solvent at an inside temperature of preferably from 0° C. to 220° C., more preferably from 50° C. to 210° C., particularly preferably from 100° C. to 200° C. for a period of from 1 to 50 hours, more preferably from 2 to 20 hours, particularly preferably from 3 to 10 hours. A metal catalyst such as palladium, nickel, tungsten or molybdenum may be used as needed.

The weight-average molecular weight of the polymer obtained by the polymerization is in the range of preferably from 1,000 to 500,000, more preferably from 5,000 to 300,000, particularly preferably from 10,000 to 200,000.

Specific examples of the compound of formula (I) are shown below.

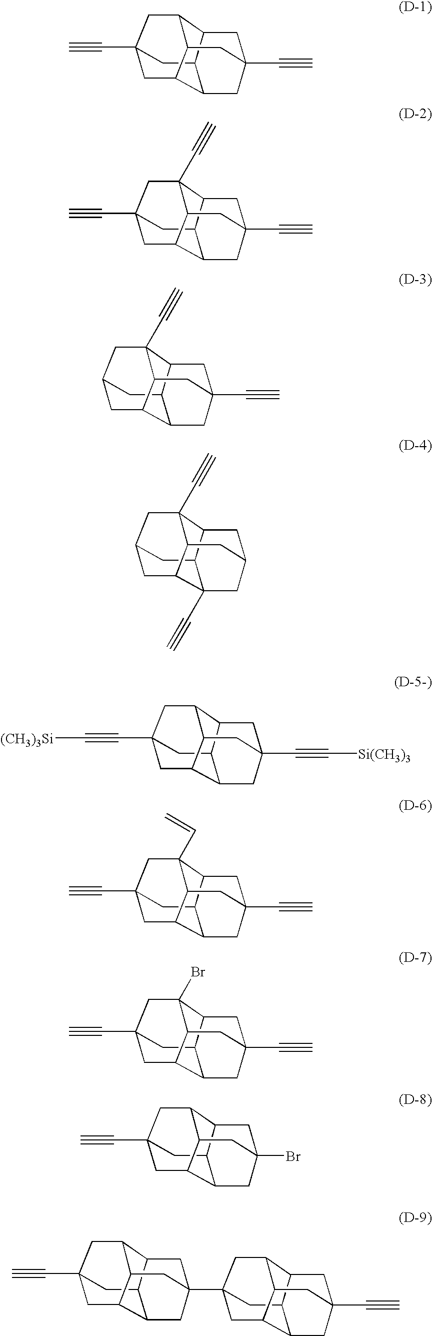

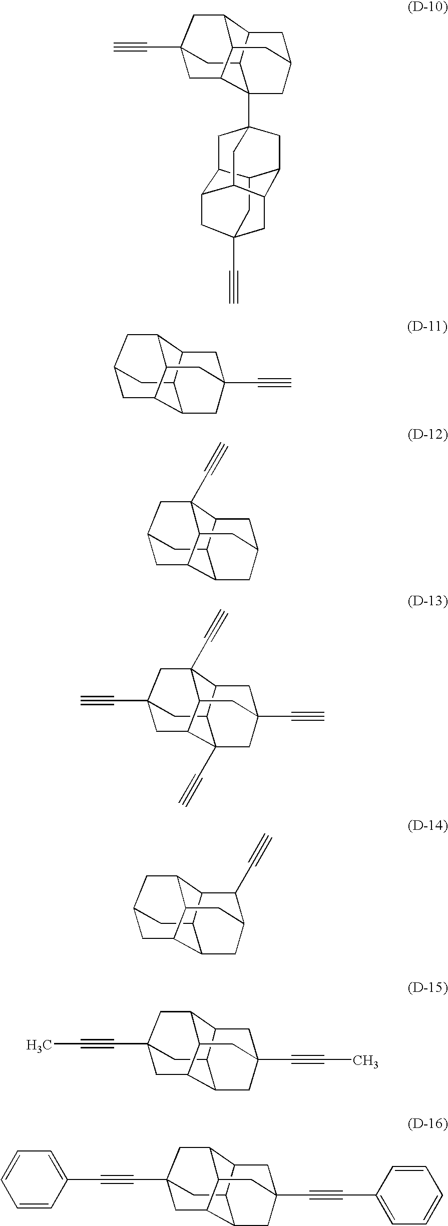

The compound of the invention preferably has a reactive group capable of forming a covalent bond with other molecule upon being irradiated with electron beams or being heated. Such reactive group is not particularly limited but, for example, those substituents which cause a cyclization addition reaction or radical polymerization reaction can preferably be utilized. For example, a group having a double bond (e.g., a vinyl group or an allyl group), a group having a triple bond (e.g., an ethynyl group or a phenylethynyl group) and a combination of a diene group and a dienophile group for causing Diels-Alder reaction are effective, with an ethynyl group and a phenylethynyl group being particularly effective.

Also, the compound of the invention having a cage structure preferably does not contain nitrogen atom which increases a molar polarization ratio and increases dielectric constant of the insulating film. Particularly, since polyimide compounds fail to provide a sufficiently low dielectric constant, the compound of the invention having a cage structure is preferably a compound other than polyimide, i.e., a compound which does not have polyimide bond and amide bond.

In view of imparting good properties (dielectric constant and mechanical strength) to the insulating film of the invention, the ratio of all carbon atoms of the cage structure to all carbon atoms of the total solid content of the film-forming composition is preferably 30% or more, more preferably from 50 to 95%, still more preferably from 60% to 90%. Here, the total solid content of the film-forming composition corresponds to the total solid content constituting the insulating film obtained from this coating solution. Additionally, those which will not remain after formation of the insulating film such as a blowing agent are not included in the solid content.

The film-forming composition for use in the invention may contain an organic solvent to use as a coating solution.

Suitable solvents which can be used in the invention are not particularly limited, and examples thereof include alcohol series solvents such as methanol, ethanol, isopropanol, 1-butanol, 2-ethoxymethanol and 3-methoxypropanol; ketone series solvents such as acetone, acetylacetone, methyl ethyl ketone, methyl isobutyl ketone, 2-pentanone, 3-pentanone, 2-heptanone, 3-heptanone and cyclohexanone; ester series solvents such as ethyl acetate, propyl acetate, butyl acetate, isobutyl acetate, pentyl acetate, ethyl propionate, propyl propionate, butyl propionate, isobutyl propionate, propylene glycol monomethyl ether acetate, methyl lactate, ethyl lactate and γ-butyrolactone; ether series solvents such as diisopropyl ether, dibutyl ether, ethyl propyl ether, anisole, phenetole and veratrol; aromatic hydrocarbon series solvents such as mesitylene, ethylbenzene, diethylbenzene, propylbenzene and 1,2-dichlorobenzene; and amide series solvents such as N-methylpyrolidinone and dimethylacetamide. These may be used independently or in combination of two or more thereof.

More preferred solvents are acetone, propanol, cyclohexanone, propylene glycol monomethyl ether acetate, methyl lactate, ethyl lactate, γ-butyrolactone, anisole, mesitylene and 1,2-dichlorobenzene.

The concentration of the solid content of the coating solution to be used in the invention is preferably from 3 to 50% by weight, more preferably from 5 to 35% by weight, particularly preferably from 7 to 20% by weight.

Further, to the film-forming composition of the invention may be added additives such as a radical generating agent, a nonionic surfactant, a fluorine-containing nonionic surfactant and a silane coupling agent within a range of not spoiling various properties (heat resistance, dielectric constant, mechanical strength, coating properties and adhesion properties) of the insulating film.

Examples of the radical generating agent include t-butyl peroxide, pentyl peroxide, hexyl peroxide, lauroyl peroxide, benzoyl peroxide, and azobisisobutyronitrile. Examples of the nonionic surfactant include octyl polyethylene oxide, decyl polyethylene oxide, dodecyl polyethylene oxide, octyl polypropylene oxide, decyl polypropylene oxide and dodecyl polypropylene oxide. Examples of the fluorine-containing nonionic surfactant include perfluorooctyl polyethylene oxide, perfluorodecyl polyethylene oxide and perfluorododecyl polyethylene oxide. Examples of the silane coupling agent include vinyltrimethoxysilane, vinyltriethoxysilane, vinyltriacetoxysilane, allyltrimethoxysilane, divinyldiethoxysilane, trivinylethoxysilane, and hydrolyzates and dehydration condensates thereof.

As to the addition amount of the additive, there exists a suitable range depending upon the use of the additive or the concentration of the solid content of the coating solution, but the addition amount is preferably from 0.001% to 10% by weight, more preferably from 0.01% to 5% by weight, particularly preferably from 0.05% to 2% by weight, based on the weight of the coating solution.

The insulating film can be obtained by coating the film-forming composition on a substrate according to an arbitrary coating method such as a spin coating method, a roller coating method, a dip coating method or a scan coating method, then irradiating the coated composition with electron beams to thereby cure the composition.

The solvent may be removed by natural vaporization or may be conducted by heat treatment prior to the irradiation with electron beams. The method for the heat treatment is not particularly limited, and a generally employed hot plate heating, a method of heating using a furnace or a method of irradiating with light using a xenon lamp in RTP (Rapid Thermal Processor) can be employed.

The method of irradiating with electron beams is not particularly limited, and an electron beam irradiation apparatus equipped with a substrate temperature-controlling mechanism and a mechanism for controlling ambient atmosphere and ambient pressure around the substrate is commercially available, which can be employed in the invention.

As to conditions for irradiation with electron beams, the acceleration voltage is preferably from 0 to 50 keV, more preferably from 0 to 30 keV, particularly preferably from 0 to 20 keV.

Also, the total dose of electron beams is preferably from 0 to 5 μCcm⁻², more preferably from 0 to 2 μCcm⁻², particularly preferably from 0 to 1 μCcm⁻².

The substrate temperature is preferably from 0 to 450° C., more preferably from 0 to 400° C., particularly preferably from 0 to 350° C.

The pressure is preferably from 0 to 133 kPa, more preferably from 0 to 60 kPa, particularly preferably from 0 to 20 kPa.

As the atmosphere around the substrate, an inert atmosphere of Ar, He or nitrogen may be employed, or a gas such as oxygen, hydrocarbon or ammonia may be added for the purpose of reacting with plasma to be generated by mutual reaction with electron beams, electromagnetic waves or chemical species.

An insulating film of 120×10⁻⁶ K⁻¹ or less, particularly 15×10⁻⁶ K⁻¹ to 60×10⁻⁶ K⁻¹, in coefficient of linear expansion can be formed by irradiating the film-forming composition containing the compound having a cage structure to thereby cure the composition as is described above. The coefficient of linear expansion can be measured according to a temperature-variable X-ray reflectivity method or a laser interference method.

The insulating film of the invention is suitable for insulation-coating film in electronic parts such as semiconductor devices, multi-chip module multilayered wiring boards, etc. Specifically, it is usable as interlayer insulating film for semiconductors, surface protective film, buffer coat film, as well as for passivation film in LSI, α-ray blocking film, cover lay film in flexographic plates, overcoat film, cover coat for flexible copper-lined plates, solder-resist film, and liquid-crystal alignment film, etc.

The thickness of the coated film is not particularly limited, but is preferably from 0.001 to 100 μm, more preferably from 0.01 to 10 mμ, particularly preferably from 0.1 to 1 μm.

It is also possible to form a porous film by previously adding a blowing agent to the insulating film-forming composition of the invention. The blowing agent to be previously added for forming the porous film is not particularly limited, and examples thereof include organic compounds having a boiling point higher than that of the solvent of the coating solution, thermally decomposable low molecular compounds, thermally decomposable high molecular compounds. low molecular compounds which can be decomposed by electron beams and polymers which can be decomposed by electron beams.

As to the addition amount of the blowing agent, there exists a suitable range depending upon the concentration of the solid content of the coating solution but, in general, the addition amount is preferably from 0.01 to 20%, more preferably from 0.1% to 10%, particularly preferably from 0.5 to 5%, in terms of % by weight in the coating solution.

### EXAMPLES

The following Examples are to describe the invention but not to restrict the scope of the invention.

Structures of compounds used in Examples are shown below.

### Synthesis Example 1

According to the method described in Macromolecules, 24, 5266 (1991), 4,9-dibromodiamantane was synthesized. Next, 1.30 g of commercially available p-divinylbenzene, 3.46 g of 4,9-dibromodiamantane, 200 ml of dichloroethane and 2.66 g of aluminium chloride were fed into a 500-ml flask, and stirred at an internal temperature of 70° C. for 24 hours. Thereafter, 200 ml of water was added to it, and the organic layer was separated through liquid-liquid separation. Anhydrous sodium sulfate was added thereto, and the solid content was removed through filtration. Then, this was concentrated under reduced pressure until dichloromethane was reduced to a half. 300 ml of methanol was added to the resulting solution, and the deposited solid was taken out through filtration. 2.8 g of a polymer (A-4) having a weight-average molecular weight of about 10,000 was thus obtained.

In the same manner, a polymer (A-12) having a weight-average molecular weight of about 10,000 was synthesized through Friedel-Crafts reaction.

### Example 1

1.0 g of the above polymer (A-4) was dissolved in a mixed solvent of 5.0 ml of cyclohexanone and 5.0 ml of anisole under heating to prepare a coating solution. After filtration through a 0.1-μ filter made of tetrafluoroethylene, this solution was spin coated on a silicon wafer, and the coated film was heated on a hot plate at 150° C. for 60 seconds in a nitrogen stream. Further, irradiation with electron beams (atmosphere: Ar; pressure: 100 kPa; substrate temperature: 450° C.; electron acceleration voltage: 20 kV; electron beam dose: 1 μCcm⁻²; Mini-EB manufactured by USHIO DENKI) was conducted. The specific dielectric constant of the thus-formed insulating film having a thickness of 0.5 p was calculated from the capacitance value thereof measured at 1 MHz by the use of Four Dimensions' mercury probe and Yokogawa Hewlett Packard's HP4285ALCR meter, and it was 2.49. The Young's modulus of the film was measured by using MTS' nano-indenter SA2, and was found to be 8.8 GPa. Measurement of coefficient of linear expansion of the insulating film using an X-ray reflectivity-measuring meter equipped with a heating stage (manufactured by RIGAKU) was conducted, and the coefficient was found to be 120×10⁻⁶ K⁻¹.

### Example 2

The same experiment as in Example 1 was conducted except for changing only the substrate temperature of the electron beam-irradiating conditions to 400° C., and the specific dielectric constant was found to be 2.48, the Young's modulus was found to be 9.0 GPa, and the the coefficient of linear expansion was found to be 105×10⁻⁶ K⁻¹.

### Example 3

The same experiment as in Example 1 was conducted except for changing only the substrate temperature of the electron beam-irradiating conditions to 350° C., and the specific dielectric constant was found to be 2.40, the Young's modulus was found to be 9.2 GPa, and the the coefficient of linear expansion was found to be 85×10⁻⁶ K⁻¹.

### Comparative Example 1

The same experiment as in Example 1 was conducted except for changing only the irradiation with electron beams to heating on a 400° C. hot plate, and the specific dielectric constant was found to be 2.52, the Young's modulus was found to be 7.2 GPa, and the the coefficient of linear expansion was found to be 160×10⁻⁶ K⁻¹.

### Example 4

1.0 g of the above polymer (A-12) was dissolved in a mixed solvent of 5.0 ml of gamma-butyrolactone and 5.0 ml of anisole under heating to prepare a coating solution. After filtration through a 0.1-μ filter made of tetrafluoroethylene, this solution was spin coated on a silicon wafer, and the coated film was heated on a hot plate at 180° C. for 60 seconds in a nitrogen stream. Further, irradiation with electron beams (atmosphere: Ar; pressure: 60 kPa; substrate temperature: 350° C.; electron acceleration voltage: 20 kV; electron beam dose: 1 μCcm⁻²; Mini-EB manufactured by USHIO DENKI) was conducted. The specific dielectric constant of the thus-formed insulating film having a thickness of 0.5μ was found to be 2.45. The Young's modulus of the film was found to be 8.5 GPa, and the coefficient of linear expansion of the insulating film was found to be 40×10⁻⁶ K⁻¹.

### Synthesis Example 2

According to the method described in Macromolecules, 24, 5266 (1991), 4,9-diethynyldiamantane was synthesized using diamantine as a starting material. Next, 10 g of 4,9-diethynyldiamantane, 50 ml of 1,3,5-triisopropylbenzene and 120 mg of Pd(PPh₃)₄ were stirred at an internal temperature of 190° C. for 12 hours. After cooling the reaction solution to room temperature, 300 ml of isopropyl alcohol was added thereto. Solids thus precipitated were collected by filtration and then washed with methanol. Thus, there was obtained 3.0 g of a polymer (A) having a weight-average molecular weight of 20,000 was thus obtained.

### Example 5

1.0 g of the polymer (A) produced in Synthesis Example 2 was dissolved in 10.0 ml of cyclohexanone to prepare a coating solution. The solution was filtered through a 0.2-micron tetrafluoroethylene filter, and then applied onto a silicon wafer in a mode of spin coating. The coated film was heat-dried on a hot plate in a nitrogen stream atmosphere at 110° C. for 90 seconds and then at 250° C. for 60 seconds. Further, irradiation with electron beams (atmosphere: Ar; pressure: 20 kPa; substrate temperature: 350° C.; electron acceleration voltage: 20 kV; electron beam dose: 1 μCcm⁻²; Mini-EB manufactured by USHIO DENKI) was conducted. The specific dielectric constant of the thus-formed insulating film having a thickness of 0.5μ was found to be 2.33. The Young's modulus of the film was found to be 9.3 GPa, and the coefficient of linear expansion of the insulating film was found to be 18×10⁻⁶ K⁻¹.

### Comparative Example 2

1.0 g of polymer (B) (obtained from SIGMA-ALDRICH) was dissolved in 10.0 ml of cyclohexanone to prepare a coating solution. The solution was filtered through a 0.2-micron tetrafluoroethylene filter, and then applied onto a silicon wafer in a mode of spin coating. The coated film was heat-dried on a hot plate in a nitrogen stream at 110° C. for 90 seconds and then at 200° C. for 60 seconds. Further, irradiation with electron beams (atmosphere: Ar; pressure: 100 kPa; substrate temperature: 450° C.; electron acceleration voltage: 20 kV; electron beam dose: 1 μCcm⁻²; Mini-EB manufactured by USHIO DENKI) was conducted. The specific dielectric constant of the thus-formed insulating film having a thickness of 0.5μ was found to be 2.55. The Young's modulus of the film was found to be 4.3 GPa, and the coefficient of linear expansion of the insulating film was found to be 150×10⁻⁶ K⁻¹.

### Comparative Example 3

The same experiment as in Comparative Example 2 was conducted except for changing only the substrate temperature upon irradiation with electron beams to 400° C., and the specific dielectric constant was found to be 2.50, the Young's modulus was found to be 5.3 GPa, and the the coefficient of linear expansion was found to be 140×10⁻⁶ K⁻¹.

### Comparative Example 4

The same experiment as in Comparative Example 2 was conducted except for changing only the substrate temperature upon irradiation with electron beams to 350° C., and the specific dielectric constant was found to be 2.60, the Young's modulus was found to be 5.8 GPa, and the coefficient of linear expansion was found to be 155×10⁻⁶ K⁻¹.

Structures of the compounds used above are shown below.

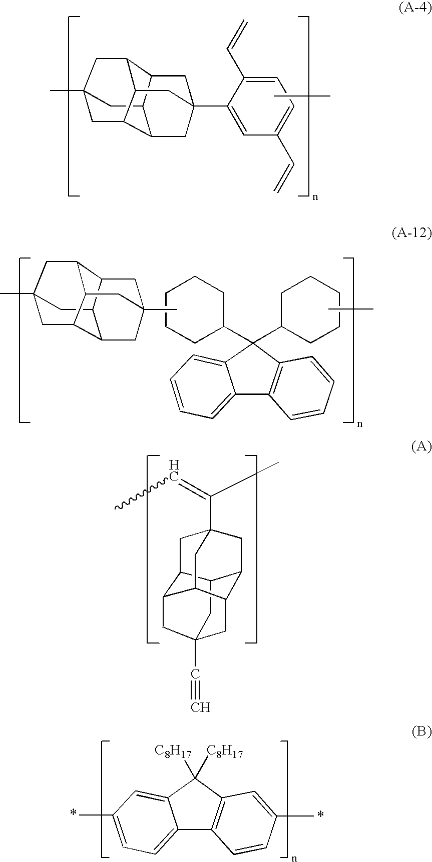

Results of the evaluations are shown in Table 1.

TABLE 1

| | | | | Coefficient |
|---|---|---|---|---|
| | | Specific | Young's | of Linear |
| | | Dielectric | Modulus | Expansion |
| | Polymer | Constant | (GPa) | (10⁻⁶ K⁻¹) |
| Example 1 | A-4 | 2.49 | 8.8 | 120 |
| Example 2 | A-4 | 2.48 | 9.0 | 105 |
| Example 3 | A-4 | 2.40 | 9.2 | 85 |
| Comparative | A-4 | 2.52 | 7.2 | 160 |
| Example 1 | | | | |
| Example 4 | A-12 | 2.45 | 8.5 | 40 |
| Example 5 | A | 2.33 | 9.3 | 18 |
| Comparative | B | 2.55 | 4.3 | 150 |
| Example 2 | | | | |
| Comparative | B | 2.50 | 5.3 | 140 |
| Example 3 | | | | |
| Comparative | B | 2.60 | 5.8 | 155 |
| Example 4 | | | | |

It is seen that the insulating film obtained by curing the composition containing the compound having a cage structure by irradiating with electron beams according to the present invention has a small specific dielectric constant, a large Young's modulous and a small coefficient of linear expansion, thus having excellent properties.

The insulating film of the invention has good film properties such as expansion of linear expansion, dielectric constant and mechanical strength. Therefore, the film can be utilized as an interlayer insulating film in an electronic device.

The entire disclosure of each and every foreign patent application from which the benefit of foreign priority has been claimed in the present application is incorporated herein by reference, as if fully set forth.

What is claimed is:

1. An insulating film comprising a compound having a cage structure,
wherein the insulating film has a coefficient of linear expansion of 120×10⁻⁶ K⁻¹ or less.

2. An insulating film, which is obtained by a method comprising:
irradiating a film-forming composition containing a compound having a cage structure with electron beams so as to cure the film-forming composition.

3. The insulating film according to claim 2,
wherein the insulating film has a coefficient of linear expansion of 120×10⁻⁶ K⁻¹ or less.

4. The insulating film according to claim 2,
wherein the cage structure is a saturated hydrocarbon structure.

5. The insulating film according to claim 2,
wherein a ratio of all carbon atoms of the cage structure to all carbon atoms of a total solid content of the film-forming composition is 30% or more.

6. The insulating film according to claim 2,
wherein the cage structure is a diamantane structure.

7. The insulating film according to claim 6,
wherein the compound having a cage structure is a polymer of at least one compound represented by formula (I): 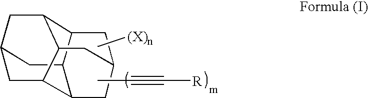
wherein R represents a hydrogen atom, an alkyl group, an alkenyl group, an alkynyl group, an aryl group or a silyl group;
m represents an integer of from 1 to 14;
X represents a halogen atom, an alkyl group, an alkenyl group, an aryl group or a silyl group; and
n represents an integer of from 0 to 13.

8. The insulating film according to claim 1,
wherein the compound having a cage structure is a compound that does not contain a nitrogen atom.

9. A process for producing an insulating film, which comprises:
irradiating a film-forming composition containing a compound having a cage structure with electron beams.

10. An electronic device comprising an insulating film according to claim 1.
